(19) United States
(12) Patent Application Publication
(10) Pub. No.: US 2009/0001115 A1
(43) Pub. Date: Jan. 1, 2009

(54) Bicycle Luggage Carrier

(76) Inventor: Aphirath T. Vongnaraj, Winnipeg (CA)

Correspondence Address: ADE & COMPANY INC., 2157 Henderson Highway, WINNIPEG, MB, R2G1P9, CA

(21) Appl. No.: 12/132,054

(22) Filed: Jun. 3, 2008

Related U.S. Application Data
(60) Provisional application No. 60/947,096, filed on Jun. 29, 2007.

(51) Int. Cl. B62J 7/04

(52) U.S. Cl. 224/452

(57) ABSTRACT

A bicycle luggage carrier for detachable mounting over a tire of a bicycle features a base and a plurality of supports connectable between the base and the bicycle frame. The base is adapted to receive a conventional backpack in a face-to-face configuration with a back panel thereof. The Detachable connection of the base and bicycle facilitates selective carrying of the backpack and base together on either a user's back or on the bicycle. Folding struts on the base are connectable to the bicycle frame on opposite sides of the tire thereof and are pivotal into a storage position in which the folding struts extend along the base. An end support on the base is connectable to the frame of the bicycle at a distance beyond a respective end of the base. A securing mechanism is operable to selectively secure the folding struts in the storage position.

This application claims the benefit under 35 U.S.C.119(e) of U.S. provisional application Ser. No. 60/947,096, filed Jun. 29, 2007.

The present invention relates to a bicycle luggage carrier for mounting over the tire of a bicycle and more particularly to a bicycle luggage carrier of this type that is detachable from a bicycle and adapted for carrying a backpack on the bicycle or on the back of a user.

### BACKGROUND

Luggage carriers arranged for mounting on a bicycle to support a rack or base in a horizontal orientation above the tire of a bicycle are well known. A number of devices have been developed with the intention of providing a backpack that is adapted for both carrying on the back of a wearer in a conventional fashion and carrying on a bicycle-mounted luggage carrier.

U.S. Pat. No. 4,433,802 of Woolf teaches a rectangular backpack frame that can have two vertically spaced pack bags hung therefrom one over the other with the frame in an extended condition. The frame is collapsible to a more compact position, in which it can be mounted over the rear wheel of a bicycle and have the pack bags hung from it on opposite sides of the wheel in a pannier arrangement.

U.S. Pat. No. 5,609,278 of Fresco teaches an articulated backpack apparatus having two storage elements movable into satchel, backpack and pannier configurations. In the pannier configuration, the apparatus may be mounted to a conventional luggage carrier previously installed on the bicycle or may be mounted to the bicycle by means of a specialized mounting bracket.

U.S. Pat. No. 5,765,733 of Brule teaches a pack that is convertible from a backpack for hiking to a pannier that can be secured to an existing pannier rack, or luggage carrier, of a bicycle.

U.S. Pat. No. 6,029,875 of Johnston teaches a knapsack specially adapted for securing to a conventional luggage carrier and for preventing the contents of the knapsack from sagging over the edges of the luggage carrier when so secured.

Each of these prior art systems for supporting a backpack on a bicycle involves the use of a specialized backpack. Furthermore, none of these references teach a carrier having a rack or frame that can be removed from the bicycle for carrying with the backpack without requiring a re-configuration between the pack and the frame.

### SUMMARY

According to a first aspect of the invention there is provided a bicycle luggage carrier for detachable mounting over a tire of a bicycle, the bicycle luggage carrier comprising:

a base defining a generally planar support surface; and

a plurality of supports connectable between the base and a frame of the bicycle to support the generally planar support surface above the tire;

the base being adapted to receive a conventional backpack having a pair of straps connected to a back panel to form loops through which a wearer's arms can be past to carry the backpack on shoulders of the wearer with the back panel extending downward along a back of the wearer, the base receiving the backpack with the support surface of the base and the back panel of the backpack in a face-to-face configuration;

the base and the supports being adapted for detachable connection of the base to the bicycle to facilitate carrying of the backpack on a user's back while secured to the base in the face-to-face configuration and carrying of the backpack on the bicycle while secured to the base in the face-to-face configuration.

Adapted to carry a conventional backpack, the luggage carrier avoids the need for a user to purchase a specialized backpack as part of the carrier when the user may already have a perfectly good conventional backpack in his/her possession. With the base fitting face-to-face with the back panel of the backpack, the single action of detaching the base from the bicycle with a backpack secured on it performs the dual function of both removing the backpack in state ready for wearing by the user and removing the base from its place over the wheel of the bicycle. In the prior art carriers, the removal of a backpack from a carrying position on a bicycle in preparation for wearing on the back of a user and the removal of a base of the carrier from the bicycle to revert the bicycle closer to its original state with no carrier installed requires multiple steps.

Preferably the plurality of supports comprise folding struts with pivotal connections, the folding struts being pivotable into a storage position with the base detached from the bicycle.

Preferably the folding struts are pivotally connected to the base and are detachably connectable to the frame of the bicycle, the folding struts extending along the base on a side thereof opposite the support surface in the storage position. The folding of the struts toward the base into the storage position extending therealong helps the luggage carrier collapse into a compact and flattened storage state when not installed on a bicycle so that it can be worn comfortably in a backpack-like fashion extending along the back of a wearer.

Preferably pivotal connections between the folding struts and the base are slidable therealong.

Preferably there is provided at least one flap secured to the base and foldable over the folding struts when in the storage position.

Preferably there is provided a releasable fastener connected to the base to selectively secure the folding struts in the storage position.

Preferably the base is adapted to allow the straps of the backpack to extend to a side of the base opposite the support surface with the backpack received thereon to facilitate carrying of the base and the backpack by the straps thereof.

Preferably the base has openings therein through which the straps of the backpack are passable to extend through the openings with the backpack received on the support surface.

Preferably the plurality of supports comprise an end support movably connected to the base to move between retracted and deployed positions, the end support extending further past a respective end of the base in the deployed position than in the retracted position.

Preferably the end support does not extend past the respective end of the base in the retracted position.

Preferably the base comprises a frame and a support body, the supports being connected to the frame and the support body defining the support surface, the frame being detachably connected to the support body.

There may be provided a pocket formed on the support surface to receive an end of the backpack.

Preferably there is provided a fastening arrangement fixed to the base to engage with the backpack for securing thereof to the base.

Preferably the fastening arrangement comprises one or more straps each fixed to the base at one end and detachably connectable to the base at an opposite end to extend over the backpack to effect securing thereof against the support surface.

Preferably the one or more straps comprise a pair of straps arranged to extend across one another when each is connected to the base at the opposite end.

The one or more straps may comprise a support strap connected to the base by a supporting flap pivotally connected to the base to be foldable against a bottom of the backpack by connecting of the support strap to the base at the opposite end of the support strap.

According to a second aspect of the invention there is provided a bicycle luggage carrier for detachable mounting over a tire of a bicycle, the bicycle luggage carrier comprising:

a support base;

a pair of folding struts pivotally connected the base to allow movement from a storage position in which the folding struts extend along the base to a use position in which the folding struts extend away from the base, the folding struts being adapted at an end opposite connection to the base for releasable connection to a frame of the bicycle on opposite sides of the tire thereof;

an end support connected to the base and arranged for releasable connection to the frame of the bicycle at a distance beyond a respective end of the support base; and

a securing mechanism associated with the base and the folding struts to selectively secure the folding struts in the storage position extending along the base.

The folding of the struts toward the base into the storage position extending therealong helps the luggage carrier collapse into a compact, flattened storage state when not installed on a bicycle.

Preferably the securing mechanism comprises fasteners supported on the base and engageable with the folding struts in the storage position.

Preferably the securing mechanism comprises at least one strap secured to the base at one end and connectable thereto at an opposite end to secure the folding struts against the base.

Preferably the securing mechanism comprises at least one flap secured to the base at one end, foldable over the folding struts, and connectable to the base at an opposite end to secure the folding struts against the base.

Preferably the end support is movably connected to the base to move between retracted and deployed positions, the end support extending further past a respective end of the base in the deployed position than in the retracted position.

### BRIEF DESCRIPTION OF THE DRAWINGS

In the accompanying drawings, which illustrate a exemplary embodiments of the present invention:

FIG. 1 is a perspective view of a body, a frame, an end support and strut supports of a first embodiment bicycle luggage carrier with the supports in deployed positions for mounting to a bicycle.

FIG. 2 is a perspective view of the body, frame, end support and strut supports of the first embodiment bicycle luggage carrier with the supports in stowed positions for carrying on the back of a wearer.

FIG. 3 is a perspective view similar to FIG. 2, but from an opposite side of the frame of the first embodiment bicycle luggage carrier.

FIG. 4 is a perspective view of one of two wheel mounts of the first embodiment bicycle luggage carrier for pivotally connecting one of the strut supports to the wheel axle of a bicycle.

FIG. 5 is a partial perspective view illustrating connection of one of the strut supports of the first embodiment bicycle luggage carrier to the wheel axle by the respective wheel mount.

FIG. 6 is a perspective view of a seat mount of the first embodiment bicycle luggage carrier for pivotally connecting the end support to the seat post of a bicycle.

FIG. 7 is a side elevational view of the seat mount of the first embodiment bicycle luggage carrier mounted to the seat post.

FIG. 8 is a top plan view of the seat mount of the first embodiment bicycle luggage carrier.

FIG. 9 is a partial perspective view of the frame, strut supports and end support with the body of the first embodiment bicycle luggage carrier removed.

FIG. 10 is a side elevational view of the frame, supports and mounts of the first embodiment bicycle luggage carrier installed on a bicycle equipped with rear suspension.

FIG. 11 is a perspective view of the frame, strut supports, end support, seat mount and wheel mounts of a second embodiment bicycle luggage carrier.

FIG. 12 is a perspective view of the seat mount of the second embodiment bicycle luggage carrier.

FIG. 13 is a perspective view of a T-shaped member defining a bottom block of the seat mount of the second embodiment bicycle luggage carrier.

FIG. 14 is a perspective view of a top block of the seat mount of the second embodiment bicycle luggage carrier.

FIG. 15 shows a supporting body of the second embodiment bicycle luggage carrier.

### DETAILED DESCRIPTION

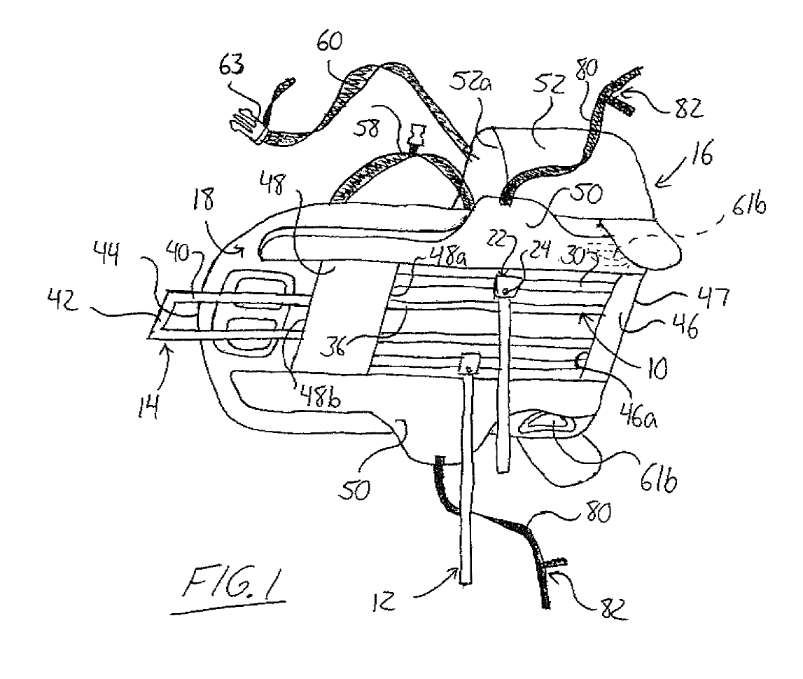

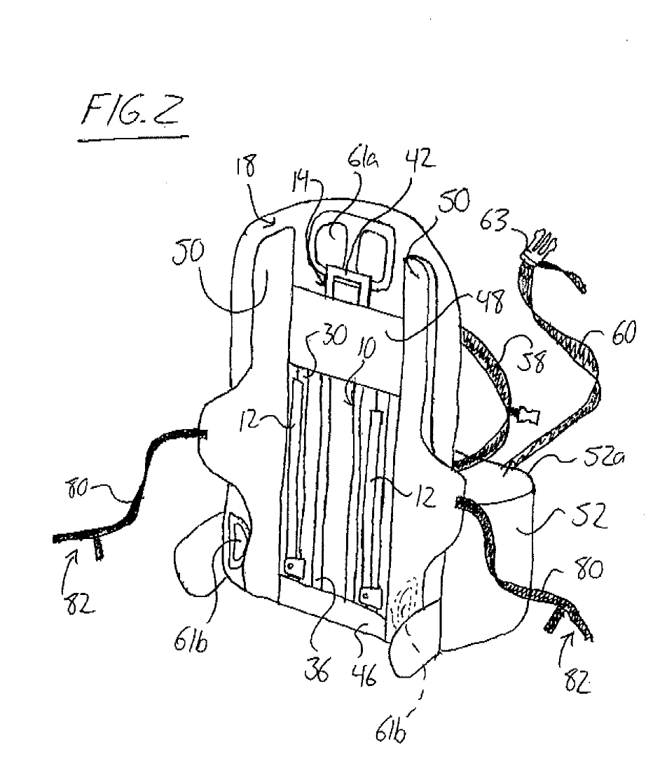

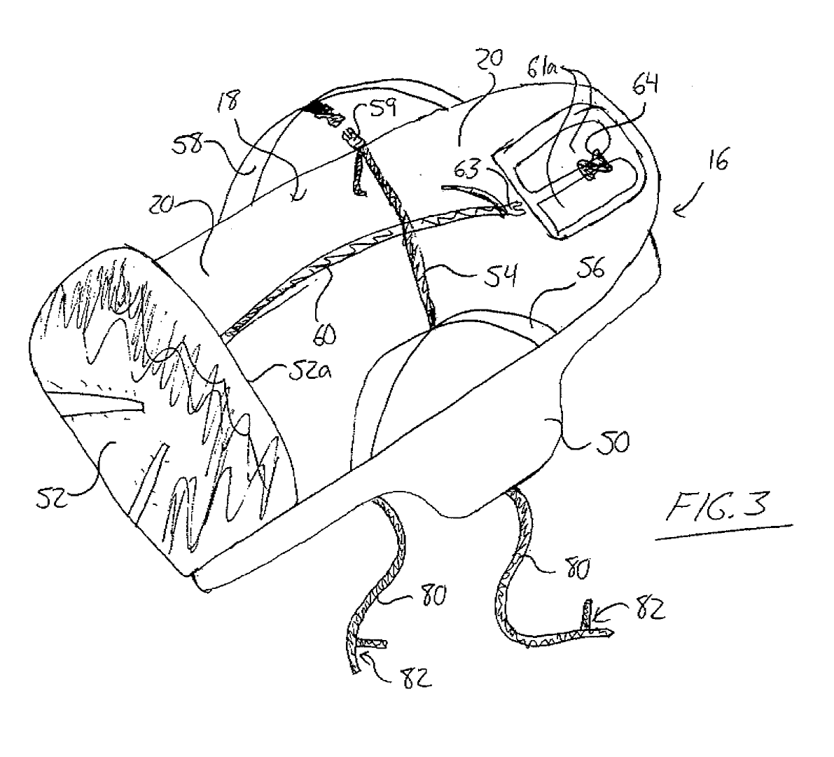

FIG. 1 shows part of a first embodiment bicycle luggage carrier adapted to carry a conventional backpack, that is a backpack having a pair of straps connected to a back panel thereof to form loops through which a wearer's arms can be passed to carry the backpack on shoulders of the wearer with the back panel extending downward along the wearer's back. The first embodiment luggage carrier features a frame 10 to be carried over the rear wheel of a bicycle in a generally horizontal orientation extending along a longitudinal axis of the bicycle, a pair of strut supports 12 coupled to frame on opposite sides of a central longitudinal axis thereof and adapted to couple to the bicycle at the ends of the strut supports opposite the frame on opposite sides of the bicycle's rear tire and an end support 14 adapted to couple to the seat post of the bicycle. On a side opposite the strut supports 12, the nearly planar frame 10 carries a support body 16, including a flat support panel 18 lying flush against the nearly planar frame 10. A face 20 of the support panel 18 opposite that resting flush against the frame 10 defines a support surface against which a conventional backpack can be secured in a face-to-face arrangement between the support surface 20 and the back panel of the backpack. FIG. 1 shows a base defined by the frame 10 and the support panel 18 in a generally horizontal orientation with the strut supports 12 and end support 14 deployed, as the carrier would be used for carrying a backpack over the rear tire of a bicycle. FIG. 2 shows the base in a generally vertical orientation with the strut supports 12 and end support 14 stowed in a more compact configuration with the frame 10 to allow carrying of the carrier and a backpack secured thereto on the back of a user in a conventional backpack fashion.

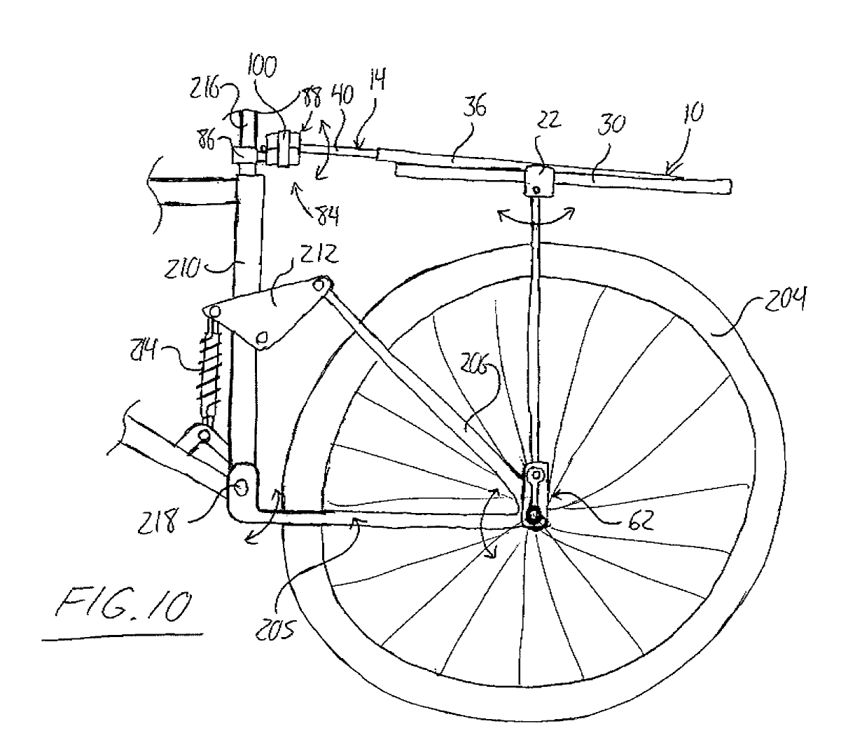

As illustrated by comparison of FIGS. 1 and 2, the strut supports 12 are each carried on the frame 10 by a respective carriage 22 that is slidably coupled to the frame for sliding movement therealong. Each strut support 12 is connected to the respective carriage 22 at a pivot 24 to facilitate pivotal movement of the strut support between a storage position, as shown in FIG. 2, and a use position, as shown in FIG. 1. In the storage position, the strut supports 12 are stowed generally parallel to the frame 10 with their ends opposite the carriages 22 sitting nearly against a side of the frame 10 opposite the support panel 18. From the storage position, the strut supports 12 are deployed toward the use position by pivoting their distal ends opposite the carriages 22 away from the frame 10 so that the strut supports 12 project away therefrom in a direction opposite the support body 18. As shown in FIG. 9, each carriage 22 features a carriage body 28 having a cylindrical bore 29 therethrough. A respective side rod 30 of the frame 10 passes through the cylindrical bore to enable sliding of the carriage along the frame. A slot or groove 32 extending along and into an end face of the body opposite the end proximate the cylindrical bore 29 receives an end of the respective strut support 12, which is pinned to the body to define the pivot 24. The slot or groove 32 extends a sufficient depth from the end face of the body relative to the distance from the end face at which the pivot pin 24 is disposed so that the support strut 12 can be folded toward the frame 10 to lie substantially parallel thereto in the storage position. Sliding of the carriage 22 and the respective strut support 12 to an end of the respective side rod 30 of the frame 10 allows maximum compactness of the frame and strut supports in the storage position by ensuring minimum or no extension of the strut supports past the opposite end of the frame 10 when the strut supports are folded over the frame into the generally parallel configuration therewith.

As shown in FIG. 9, the two parallel side rods 30 of the frame 10 are connected at their ends by parallel cross members 34 extending perpendicularly between the two side rods 30. Between the two side rods 30 defining the sides of the frame is a pair of parallel tubes 36 spaced apart from one another and spaced from each of the two side rods 30 in an orientation generally parallel thereto. At one end, the two tubes 36 are fixed to but do not extend past the respective cross member 34. At an opposite end 38, the two tubes 36 extend slightly passed the respective cross member 34, this opposite end 38 of each tube 36 being open to receive ends of the U-shaped end support 14, having two parallel leg portions 40 connected by a central portion 42 at one end. The leg portions are of suitable cross-sectional size to be received within the hollow parallel tubes 36, for sliding motion of the end support 14 along the frame 10. As shown by comparison of FIGS. 1 and 2, the end support 14 is deployable to a use position projecting past a respective end 44 of the support body 18 to dispose the end portion 42 of the end support in a space that is unobstructed by the support body for connection to a seat post of a bicycle. From this position, the end support 14 is retractable further back into the tubes 36 of the frame 10 to the storage position of FIG. 2, where the end support 14 does not project past the respective end 44 of the support body 18. Extending further from the respective end of the frame 10 in the use position than in the storage position, the sliding end support 14 improves the compactness of the first embodiment luggage carrier in the storage position by reducing its overall length.

The support panel 18 of the support body 16 is of greater length and width than the frame 10 and is sufficiently rigid to support a conventional backpack of greater width than the frame 10 thereatop when the luggage carrier is mounted to a bicycle to position the support body horizontally over the rear tire, without the backpack sagging over the sides of the frame 10. As shown in FIGS. 1 and 2, a frame pocket 46 is fixed to the support panel 18 at an end 47 thereof opposite the end 44 past which the end support 14 projects in the use position. The rectangular frame pocket 46 fixed to the side of the support body 18 opposite the support surface 20 is open along a side 46a thereof facing the other end of the support body 16 so as to receive the end of the frame 10 opposite the end support 14. A second frame pocket 48 is fixed to the same side of the support panel 18 at a distance therealong from the first frame pocket 46 and opens theretoward at side 48a to received the opposite end of the frame 10, that is the end at which the end support 14 is disposed. The rectangular second frame pocket 48 is also partially opened along another side 48b thereof opposite the first frame pocket 46 to allow the end support 14 to pass through the second frame pocket 48. The opening along this side 48b is too small to allow passage of the frame end therethrough. The frame ends fit snugly within the frame pockets 46, 48 so that they act as bands or straps to secure the support body 16 on the frame 10. The depth of the second frame pocket 48, that is the perpendicular distance between its open side 48a and its partially open side 48b, is such that the frame 10 can be removed from the support body 16 by pulling the frame 10 out of the first frame pocket 46 further into the second frame pocket 48, pulling the so freed end from away from the support body 16 and then withdrawing the frame 10 from the second frame pocket 48.

On opposite sides of the frame receiving space defined between the two frame pockets 46, 48 are flaps 50, each fixed to the face of the support panel 18 opposite the support surface 20 along one end of the flap. The flaps 50 can be folded over the frame 10 disposed therebetween with the strut supports 12 in the storage position parallel and nearly flush to the frame 10 and secured in this folded configuration to cover the tubes and rods of the frame and the strut supports secured thereto. The flaps 50 act to help maintain the strut supports 12 in the storage position when the combination of the frame, the supports and the supporting body is worn on the back of a user to carry a backpack. The flaps also offer improved comfort during such wearing by providing padding between the wearer's back and the hard frame and support components.

A storage pocket 52 is defined on the support surface side of the support panel 18 at the same end 47 of the support body 16 as the first frame pocket 46. The storage pocket 52 is closed at the end 47 of the support body and opens at an opposite side 52a toward the end of the support body 44 past which the end support 14 is extendable. Thus a backpack having its rear panel placed in a face-to-face arrangement with the support surface 20 of the support panel 18 and slid therealong from the end 44 thereof opposite the storage pocket will have its bottom end (the lowermost end of the backpack when adorned on a wearer's back in a conventional fashion by hanging from the shoulders) slid into the storage pocket 52. The storage pocket 52 prevents sliding of the backpack off the end 47 of the support body 18 at which it is disposed, both when the combination is worn in a generally vertical orientation on a user's back and when the combination is carried over the rear wheel of a bicycle in a generally horizontal orientation. Securing of the backpack to the support body 16 is completed by fastening straps provided on the support surface side of the support panel 18. A cross-wise strap 54 is fixed at one end to a loop formed at one side of the support panel 18 by a band 56 fixed at both ends thereto. A second band 58 is likewise provided at the opposite side of the support panel. The second band 58 and the cross-wise strap 54 are provided with opposite mating halves of a snap clip fastener. Being a well-known type known to those of skill in the art, the fastener has its male half 59, pictured on the cross-wise strap 54, adapted for tensioning of the strap over a backpack received in the storage pocket 52 between the bands 56, 58. A lengthwise strap 60 is fixed at one end thereof to the storage pocket 52 to be extendable from a central point at the open side 52a thereof toward the opposite end 44 of the support body 16. A tensioning male half 63 and a female half 64 of another snap clip fastener are provided on the lengthwise strap 60 and on the support surface side of the support panel 18 respectively. The storage pocket 52 and the two crossing straps firmly secure the backpack to the support panel 18.

Reinforced openings are provided extending through the support panel 18, two separate but closely adjacent openings 61a near the end 44 of the support body 16 opposite the storage pocket 52 and two further spaced openings 61b near the opposite end 47. The second pair of openings 61b extend through the support panel 18 to communicate with the interior of the storage pocket 52 on opposite sides of the first frame pocket 46. The openings allow that straps of a conventional packback, which are typically fixed to the back panel of the backpack at the top end thereof (nearest the shoulders of a wearer when worn) and releasably connected at their opposite ends nearer the bottom of the backpack, can be passed through the first openings 61a from the support surface side of the support panel 18 on which the backpack is disposed and extended down to the second openings 61b to pass back through the panel for connection to the backpack near its bottom end receivable in the storage pocket 52. This way, when the support body 16, frame 10 and supports 12, 14 are removed from a bicycle with a backpack already secured to them, the existing straps of the backpack can be used to carry the entire combination without the need to equip the support body with its own set of redundant straps.

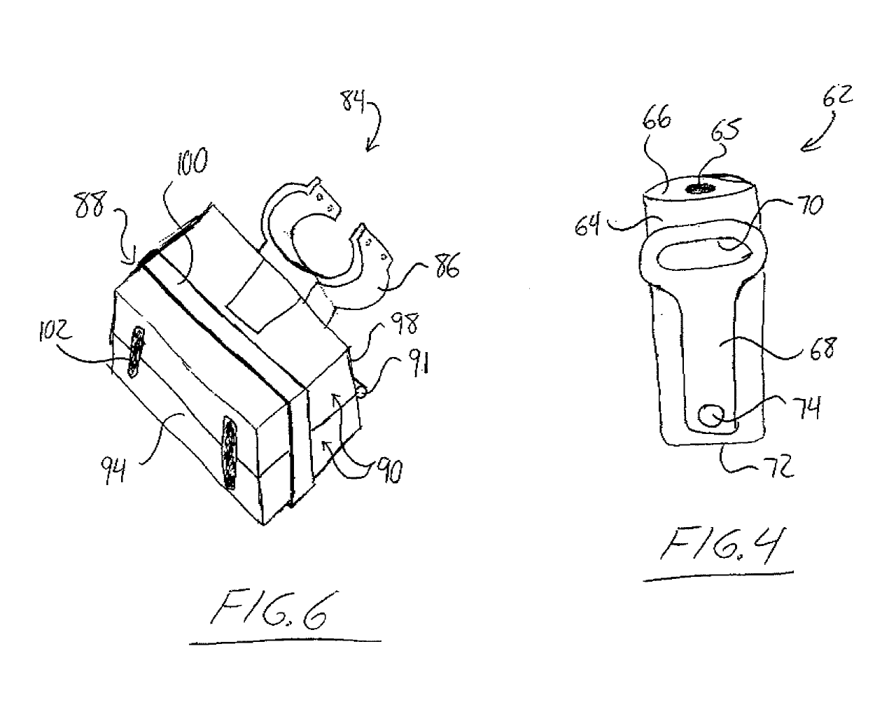

FIGS. 4 and 5 show a wheel mount 62 used on each side of a bicycle tire to secure a respective one of the two strut supports 12 to the bicycle. The wheel mount 62 features a mounting body 64 having a cylindrical bore 65 projecting thereinto, but not fully therethrough, from a top end face 66 of the mounting body 64. Fixed to one side of the mounting body 64 is a tie-down anchor 68 having an eye 70 defined therethrough. Proximate, but spaced from, a bottom end 72 of the wheel mount 62, a cylindrical bore 74 extends cross-wise therethrough, sized to receive an end of the axle of the rear wheel of the bicycle, shown schematically at 76 in FIG. 5. The wheel mount 62 is placed over the end of the axle outside the two rear forks of the bicycle, followed by an end cap 78 that prevents the wheel mount 62 from sliding off the axle. The blind cylindrical bore 65 is sized to receive an end of the respective strut support 12 opposite the connection thereof to the frame 10, as shown in FIG. 5, to help support the frame 10 above the rear tire of the bicycle. As the distal end of the strut support 12 only sits, and is not locked or secured, in the blind cylindrical bore 65 of the mounting body 64, a tie-down strap 80 is fixed to each of the flaps 50 on the support panel 18. These two tie-down straps have branched ends 82 and are each of are sufficient length to extend downward from the respective flap 50 hanging downward from the support panel 18 when installed on the bicycle to the eye 70 of the tie-down anchor 68 of the respective wheel mount 62 for tying of the two branches formed at the end of tie-down strap through the eye 70. Tied sufficiently tight and taught, the straps prevent the strut supports 12 from withdrawing upwardly from the wheel mounts 62 during riding of the bicycle with the first embodiment luggage carrier installed.

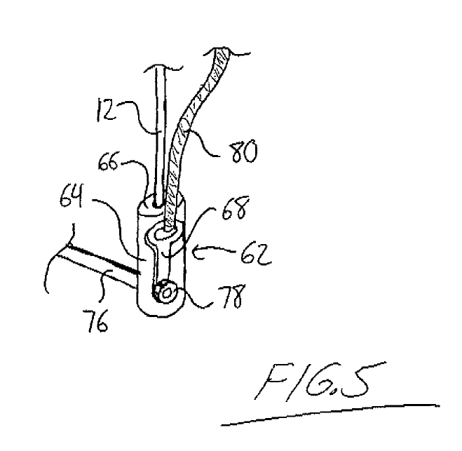

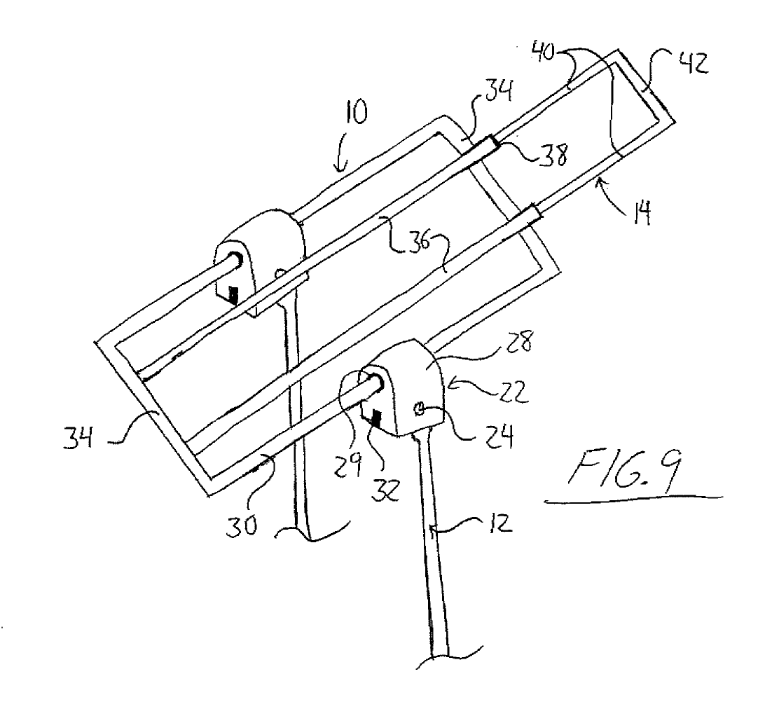

FIGS. 6 to 8 show a seat mount 84 for connecting the end support 14 to the seat post of a bicycle when in the extended or use position. The seat mount 84 features a C-clamp 86 sized to fasten around the seat post in a well known conventional manner. A coupling device 88 is fixed to the C-clamp 86 and features two block-like halves 90 pivotally connected by a pair of hinges 91 disposed on opposite sides of the C-clamp 86 at the same end of the device. The C-clamp is fastened to one of the two halves 90, the other half being pivotal relative to the fastened half to open and close in hinged fashion into and out of face-to-face engagement. The faces of the two block-like halves 90 are mirror images of one another, each having a groove therein that is U-shaped in plan as shown in FIG. 8, corresponding to the U-shape of the end support 14 received in the tubes 36 of the frame 10. With the mirrored halves mated together as shown in FIGS. 6 to 8, the aligned grooves form a channel 95 that is U-shaped in plan, having two end portions 92 extending perpendicularly into an end 94 of the coupling device 88 opposite the C-clamp 86 and a central portion 96 perpendicularly connecting the two end portions at a distance from the C-clamp equipped end 98. When the two block-like halves are pivotally opened to separate their grooved matable faces, the end support 14 is inserted between these faces into the groove in one of the halves. The halves are closed together over the end of the end support 14 with the central portion 42 of the end support 14 disposed within the central portion 96 of the channel 95 and the ends of the end support's leg portions 40 disposed in the parallel end portions 92 of the channel. A hook and loop fastening strap 100 is then tightened around the closed coupling device to prevent inadvertent opening and release of the support end secured therein.

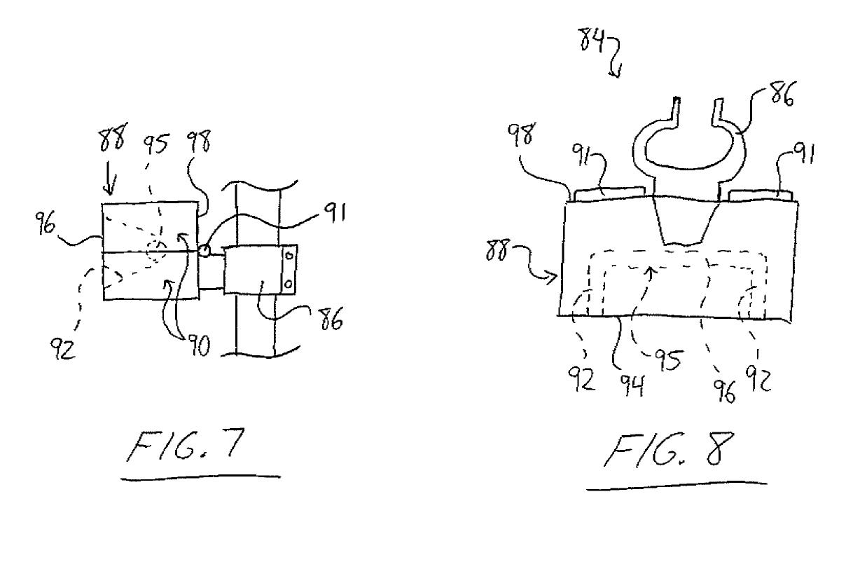

As shown in FIG. 7, the central portion 96 of the channel 95 is cylindrical with a circular cross-section corresponding to the round cylindrical central portion 42 of the end support 14. However, the end portions 92 of the channel 95 do not have a cylindrical cross section, but instead each taper in height inward from a maximum height at the end 94 of the coupling device to the point of intersection with the central portion 95. This shaping of the channel 95 is accomplished by appropriately shaping the grooves in the mating faces of the two block-like halves, that is by shaping the central portion of each groove to have a semi-circular cross section and by increasing the depth of each end portion of each groove from the mating face of the respective half away from the central portion to the end 94 of the coupling device 88 opposite the C-clamp 86. The wide opening 102 formed at the end 94 of the coupling device allows the end support 14 and the frame 10 connected thereto to pivot about a common central longitudinal axis shared by the central portion 96 of the channel 95 defined by the coupling device 88 when closed and the central portion 42 of the end support 14 disposed therein to couple the end support 14 and frame 10 to a seat post of a bicycle.

FIG. 10 illustrates installation of the first embodiment luggage carrier on a bicycle, schematically illustrated at 200, with the support body 16 removed from the frame. The seat mount 84 clamps to the seat post 202 of the bicycle and each wheel mount 62 is pivotally secured on the axle of the rear wheel 204 of the bicycle outside the rear fork 206 of a respective side of the wheel 204. The illustrated bicycle features a rear suspension system in which the rear frame assembly 205, including the rear fork 206, is pivotally mounted to the front frame assembly 208 near the bottom of the seat tube 210 and also connected further up the seat tube by a link 212 pivotally mounted thereto and connected to the front frame assembly via a spring and damper assembly 214. With the seat mount 84 and the end support 14 providing a pivotal connection of the frame 10 to the seat post 216, the carriage 22 providing the pivotal connection 24 between the frame 10 and the strut supports 12 and the wheel mounts 62 providing pivotal connection of the support struts 12 to the bicycle's rear frame assembly 206, a four bar linkage is defined by the seat tube and seat post forming a fixed first ground link, the rear frame assembly 206 connected to the seat tube at pivot 218 near the bottom end thereof forming a moving second link, the strut supports 12 forming a moving third link, and the frame 10 and end support 14 forming a moving fourth link connecting back to the fixed ground link. The pivotal connections between the links allow limited relative motion between them as generally indicated by double-ended arrows in FIG. 10. The luggage carrier is thus adapted to move with the moving rear frame assembly 206 of a bicycle equipped with rear suspension.

It should be appreciated that the luggage carrier of the present invention is not limited to use on a bicycle equipped with rear suspension as described above, and for example may be used on a hardtail bicycle in which the rear fork or seat stay is fastened to the seat tube in a fixed position relative thereto. The hook and loop fastener strap may be replaced with other fasteners known to those of skill in the art to secure the two halves of the seat mount coupling device together in a closed use position. The structure of the coupling device may be altered to eliminate the end portions of the channel, extend the cylindrical central section through to both external sides of the coupling device and reduce the length of the device (measured cross-wise to the bicycle's longitudinal axis when installed) so that it closes only over the central portion of the end support. In such an arrangement, the halves of the coupling device would not close over the leg portions of the end support, leaving them free on opposite sides of the device to move under pivoting of the central portion of the end support about its central axis without the need for widened end channel portions.

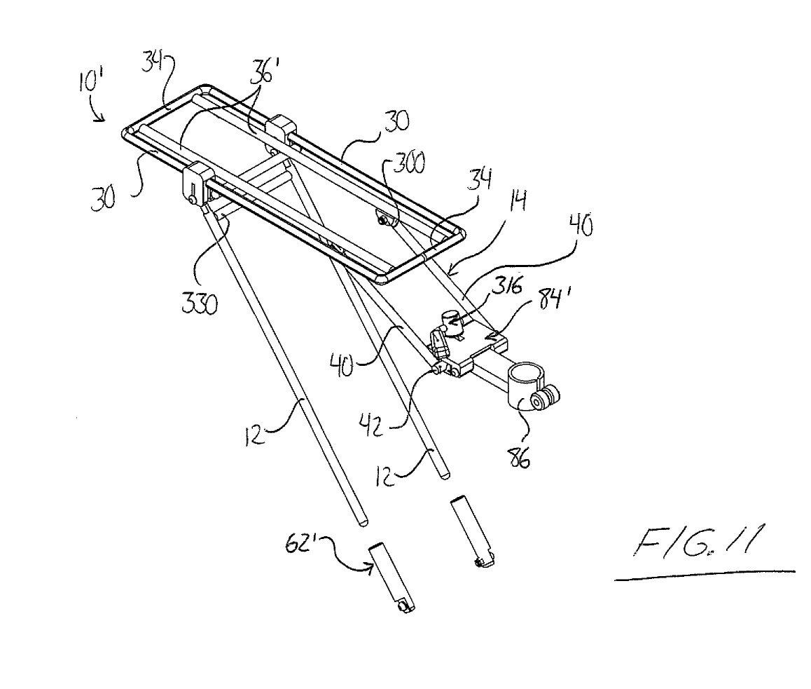

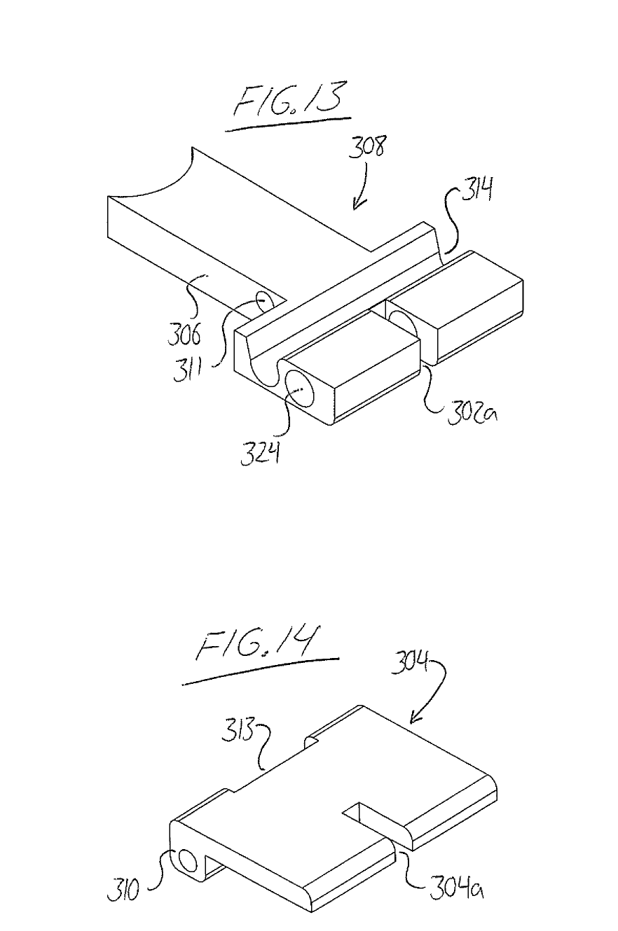

Components of a second embodiment luggage carrier featuring examples of such alternate arrangements are shown in FIGS. 11 to 15.

With reference to FIG. 11, the frame 10′ of the second embodiment is similar in structure to that of the first, with the most notable difference being in the mounting and operation of the end support 14 relative to the frame 10′. The structure of the two parallel side rods 30 and cross members 34 is the same as in the first embodiment frame, but the two tubes 36′ mounted between the side rods 30 do not extend past either cross member 24. Instead, the two tubes 36′ lie entirely parallel to the side rods 30 (not having to slope over or under one of the cross members 34 to pass thereover or thereunder as in the first embodiment) and have their ends fixed to the cross members 34. In the second embodiment, the U-shaped end support 14 is not slidably received in the two tubes 36, but instead is has its two parallel leg portions 40 pivotally connected to the two respective tubes 36 to allow pivoting of the end support 14 toward and away from the plane of the frame 10 in a manner similar to the strut supports 12. Pivot mounts 300 carrying the end support 14 for pivoting on the same side of the frame as the strut supports 12 are located proximate the same end of the frame from which the end support slides in the first embodiment. Thus the end support 14 may be pivoted to extend toward the opposite end of the frame 10′ in a retracted position generally flush against the bottom thereof, and may be pivoted out of this position by more than ninety degrees to extend to a use position similar to that of the first embodiment, as shown in FIG. 11. The end support 14 is thus movable between a storage position where the end support 14 does not project outward from the frame 10′ and a use position extending past the respective end of the frame 10′. As in the first embodiment, this improves the compactness of the first embodiment luggage carrier in the storage position by reducing its overall length. As shown in the figures, the pivot mounts may be defined by lugs projecting downward from the tubes 36′ and threaded fasteners passing through and secured to the lugs and the legs of the end support to define the pivot axis thereof.

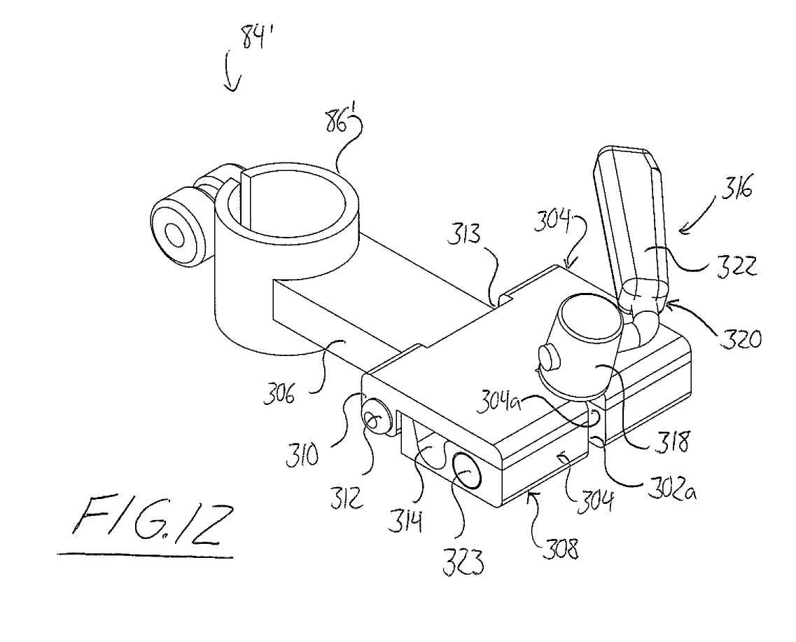

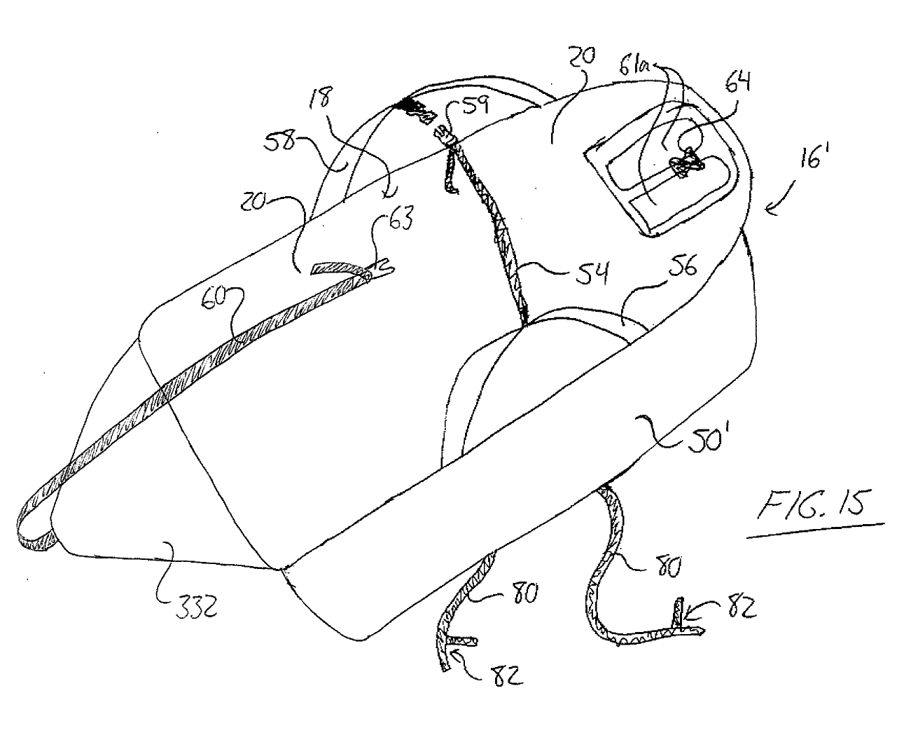

FIG. 12 shows the seat mount 84′ for connecting the end support 14 of the second embodiment to the seat post of a bicycle when in the extended or use position. The seat mount 84 again features a seat post clamp 86′ and features two pivotally connected block-like halves 302, 304. The bottom block 302 is defined by one leg of a T-shaped member 308, the other leg of this member having the seat post clamp 86′ supported at its end opposite the bottom-block-defining leg 302. The top block 304 lies over the bottom block 302 face to face therewith when the seat mount 84′ is closed and also extends past the bottom block 302 along the clamp supporting leg 306 of the T-shaped member 308 in this closed condition. Here, at a distance past the perimeter of the bottom block 302, the top block 304 features a pair of lugs 310 projecting perpendicularly downward from the bottom face of the top block 304 on opposite sides of the clamp-supporting leg 306. A pivot pin 312 passes through the lugs 310 and a hole 311 extending perpendicularly through the clamp supporting leg 306 and parallel to the bottom block 304, thereby pivotally supporting the top block 304 on the T-shaped member 308 defining the bottom block 302. Between the lugs 310, the top block 304 is notched along its edge facing the clamp 86 by a sufficient distance to allow pivoting of the top block 304 through ninety degrees from the closed position of FIG. 12 by accommodating a top portion of the clamp-supporting leg 306 of the T-shaped member 308. This notch is labelled 313 in FIGS. 12 and 14.

Unlike the first embodiment, the faces of the two block-like halves 302, 304 are not mirror images of one another. Instead, the bottom block 302 has a linear groove 314 recessed thereinto from the top face thereof, extending fully across the bottom block 302 in a direction parallel to the pivot pin 312 and perpendicular to the clamp-supporting leg 306 and having a rounded bottom of generally semi-circular shape in a cross sectional plane of the groove 314. No corresponding groove is provided in the top block 304. The central portion 42 of the end support 14 pivotally carried on the frame 10′ is laid into this groove 314 when the seat mount 84′ is opened to expose the flat matable faces of the blocks 302, 304, the central portion 42 of the end support 14 having a diameter slightly smaller than the rounded bottom of the groove 314. The central portion 42 is thus rotatable about its longitudinal axis when laid in the groove 314 and is also longer than the groove 314 so as to support the leg portions 40 of the end support 14 outside the blocks 302, 304 of the seat mount 84′ on opposite sides thereof for pivoting together about the axis of the central portion 42 housed within the blocks when the blocks are closed together with the bottom face of the top block 304 closing off the groove 314 in the bottom block from above.

The seat mount 84′ is equipped with a quick release mechanism 316 used to selectively lock the blocks 302, 304 in the closed position. The quick release mechanism is similar to a type commonly used to tighten a C-shaped seat post clamp, like that of the seat mount, around the seat tube of a bicycle frame at a slotted upper end thereof to tighten the seat tube around the seat post received therein to clamp the seat post in place to set a desired height of the seat above the upper end of the seat tube. The mechanism features a cylindrical cap or housing 318 slidably fitted over a cam follower defined by a head affixed to a respective end of a control rod. A cam lever 320 passes through the housing 318 and the head of the control rod in a direction perpendicular to the control rod's longitudinal axis, defining an eccentric cam within a transverse bore passing through the head of the control rod. A handle 322 of the cam lever 320 projects laterally from the cam-defining portion of the lever at a position outside the housing 318 slidably encompassing the head of the control rod. The handle is operable to rotate the eccentric cam to effect relative sliding displacement between the control rod and the housing 322 along the control rod's axis.

An end of the control rod opposite the head thereof and the housing cap 318 slidably disposed thereover is fixed to a shaft 323 extending perpendicular to the control rod, for example by way of a threaded end of the control rod being engaged with a threaded hole extending into the shaft 323 perpendicular to the axis thereof. The shaft is rotatably housed in a bore 324 passing through the bottom block 302 of the seat mount 84′ parallel to the groove 314 on a side thereof opposite the pivot pin 312 pivotally connecting the two blocks 302, 304. The top and bottom blocks 302, 304 feature respective slots 302a, 304a extending thereinto from their ends opposite their connection to one another. When the blocks are closed together face to face, the slots 302a, 304a align with one another, extending linearly into the blocks toward the supporting leg 306 of the T-shaped member 308 by equal amounts, perpendicularly intersecting the bore 324 and reaching, but not crossing, the groove 314. Each slot 302a, 304a spans the full thickness of the respective block 302, 304 such that the aligned slots extend fully through the two blocks when the blocks are closed together. With reference to FIG. 12, the control rod of the quick release mechanism projects from the shaft 323 on which it is fixed through the aligned slots 302a, 304a to support its head and the housing cap 318 outside the blocks 302, 304. With the shaft rotated to position the housing cap 318 over the top block 304 on a side thereof opposite the bottom block 302, the cam lever is operable into a closed position to push the housing 318 along the control rod against this top side of the top block 304 on opposite sides of the slot 302a therein to clamp the blocks 302, 304 together in the closed position, face-to-face against one another. Operation of the cam lever from this condition into an opposite open position slidingly removes the housing 318 from against the top block 302 to release this clamping effect. To facilitate opening of the blocks 302, 304, the handle 322 of the cam lever 320 is pulled to rotate the shaft within the bore 324 so as to pivot the control rod away from the supporting leg 306 toward the bottom block 304, moving the housing cap 318 in an arcuate path about the shaft outside the blocks 302, 304 at the ends thereof opposite the clamp-supporting leg 306 to remove the cap 318 from its position over the top block 302 so that it no longer blocks pivoting of the top block 304 into the open position.

As shown in FIG. 11, the wheel mounts 62′ of the second embodiment are of generally the same structure as those of the first embodiment, with the most notable exception that they do not include tie-down anchors. It will be appreciated that the wheel mounts 62′ need not necessarily be mounted at the wheel axle of the bicycle and, for example, may be instead pivotally mounted elsewhere on the rear frame assembly 205 of the rear suspension bicycle of FIG. 10. The strut supports 12 may alternatively connect, for example, to the seat tube 210 in arrangements where the carrier is not movable with a suspension-equipped rear wheel, in which case the carrier frame, end support, seat mount and strut supports would cooperate with the seat post and seat tube of the bicycle to define a generally triangular rigid support structure when installed. In such an arrangement, pivotal or non-pivotal connections between the luggage carrier and the bicycle could be used.

Referring again to FIG. 11, a cross bar member 330 rigidly and perpendicularly connects the pivoting strut supports 12 of the second embodiment to link these supports a parallel arrangement with one another for movement together, the cross bar member 330 being positioned proximate the connection of the strut supports 12 to the frame 10′ so as to be positioned above and spaced from the bicycle wheel when the luggage carrier is installed and used thereon.

With reference to FIG. 15, a support body 16′ of the second embodiment luggage carrier does not feature a storage pocket like the first embodiment. Instead, a triangular supporting flap 332 is foldably or pivotally connected to the base panel 18 at the same end thereof as the first embodiment pocket, spanning generally the full width of the base panel 18 at its connection thereto and narrowing away from this connection. At an end of the supporting flap 332 opposite its flexible connection to the support panel 18, at the point defined centrally along the base panel's width dimension by the supporting flap's triangular shape, the support body 16 once again features a lengthwise strap 60 equipped with a male half 63 of a snap clip fastener at an end of the strap 60 opposite its stitched or otherwise substantially permanent connection to the supporting flap. In use, once a backpack is laid with its back against the support surface 20 of the supporting panel 18, with the triangular flap 332 of the supporting body laid out to project from the respective end of the support panel 18 as shown in FIG. 15, the fastening end 63 of the lengthwise strap 60 is pulled over the backpack and engaged with the corresponding female fastener component 64 centrally located proximate the opposite end of the support panel 18. The length of the strap 60 is adjusted in a known manner at its connection to the male fastener component 63 to tension the strap 60 snugly over the front of the backpack. This connection and fitting of the lengthwise strap 60 folds, pivots or pulls the support flap 332 up against the bottom of the backpack positioned at the respective end of the base panel 18 and holds the support flap in this position. When the backpack and the support body are worn on the back of a user, the support flap is thus held in a position extending outward from the support surface 20 of the support panel 18 at a position immediately beneath the backpack for support thereof from below.

Still referring to FIG. 15, the second embodiment support body 16′ features no bottom openings in the panel opposite the top opening 61a, as the lack of a pocket closing fully around the bottom end of the backpack due to the use of the support flap 332 instead means that the backpack straps can pass from the support surface side of the support panel 18 to the opposite side for connection to the backpack proximate the bottom thereof simply by each extending around the respective side edge of the support panel 18 proximate the support flap end thereof. The second embodiment support body 16′ also differs in that the flaps 50′ fixed to the face of the support panel 18 opposite the support surface 20 are each of uniform width over their common length, these uniform widths being sufficient so that the flaps overlap each other over their full lengths when folded over one another and secured in place, for example by tying of straps 80 to one another or two other features of the support body, to retain the pivoting support struts 12 and pivoting end support of the second embodiment in their stowed positions against the frame 10. This differs from the first embodiment where the flaps 50 instead each jut or flare out to an extended width at a central position along its length so that the two flaps only overlap with one another over the pivotal support struts 12 at these centrally positioned projections.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bicycle luggage carrier for detachable mounting over a tire of a bicycle, the bicycle luggage carrier comprising:
a base defining a generally planar support surface; and
a plurality of supports connectable between the base and a frame of the bicycle to support the generally planar support surface above the tire;
the base being adapted to receive a conventional backpack having a pair of straps connected to a back panel to form loops through which a wearer's arms can be past to carry the backpack on shoulders of the wearer with the back panel extending downward along a back of the wearer, the base receiving the backpack with the support surface of the base and the back panel of the backpack in a face-to-face configuration;
the base and the supports being adapted for detachable connection of the base to the bicycle to facilitate carrying of the backpack on a user's back while secured to the base in the face-to-face configuration and carrying of the backpack on the bicycle while secured to the base in the face-to-face configuration.

2. The bicycle luggage carrier according to claim 1 wherein the plurality of supports comprise folding struts with pivotal connections, the folding struts being pivotable into a storage position with the base detached from the bicycle.

3. The bicycle luggage carrier according to claim 2 wherein the folding struts are pivotally connected to the base and are detachably connectable to the frame of the bicycle, the folding struts extending along the base on a side thereof opposite the support surface in the storage position.

4. The bicycle luggage carrier according to claim 3 wherein pivotal connections between the folding struts and the base are slidable therealong.

5. The bicycle luggage carrier according to claim 3 further comprising at least one flap secured to the base and foldable over the folding struts when in the storage position.

6. The bicycle luggage carrier according to claim 3 further comprising a releasable fastener connected to the base to selectively secure the folding struts in the storage position.

7. The bicycle luggage carrier according to claim 1 wherein the base is adapted to allow the straps of the backpack to extend to a side of the base opposite the support surface with the backpack received thereon to facilitate carrying of the base and the backpack by the straps thereof.

8. The bicycle luggage carrier according to claim 1 wherein the plurality of supports comprise an end support movably connected to the base to move between retracted and deployed positions, the end support extending further past a respective end of the base in the deployed position than in the retracted position.

9. The bicycle luggage carrier according to claim 8 wherein the end support does not extend past the respective end of the base in the retracted position.

10. The bicycle luggage carrier according to claim 1 wherein the base comprises a frame and a support body, the supports being connected to the frame and the support body defining the support surface, the frame being detachably connected to the support body.

11. The bicycle luggage carrier according to claim 1 further comprising a fastening arrangement fixed to the base to engage with the backpack for securing thereof to the base.

12. The bicycle luggage carrier according to claim 11 wherein the fastening arrangement comprises one or more straps each fixed to the base at one end and detachably connectable to the base at an opposite end to extend over the backpack to effect securing thereof against the support surface.

13. The bicycle luggage carrier according to claim 12 wherein the one or more straps comprise a pair of straps arranged to extend across one another when each is connected to the base at the opposite end.

14. The bicycle luggage carrier according to claim 12 wherein the one or more straps comprise a support strap connected to the base by a supporting flap pivotally connected to the base to be foldable against a bottom of the backpack by connecting of the support strap to the base at the opposite end of the support strap.

15. A bicycle luggage carrier for detachable mounting over a tire of a bicycle, the bicycle lug folding gage carrier comprising:
a support base;
a pair of folding struts pivotally connected the base to allow movement from a storage position in which the folding struts extend along the base to a use position in which the folding struts extend away from the base, the folding struts being adapted at an end opposite connection to the base for releasable connection to a frame of the bicycle on opposite sides of the tire thereof;
an end support connected to the base and arranged for releasable connection to the frame of the bicycle at a distance beyond a respective end of the support base; and
a securing mechanism associated with the base and the folding struts to selectively secure the folding struts in the storage position extending along the base.

16. The bicycle luggage carrier according to claim 15 wherein the securing mechanism comprises fasteners supported on the base and engageable with the folding struts in the storage position.

17. The bicycle luggage carrier according to claim 15 wherein the securing mechanism comprises at least one strap secured to the base at one end and connectable thereto at an opposite end to secure the folding struts against the base.

18. The bicycle luggage carrier according to claim 15 wherein the securing mechanism comprises at least one flap secured to the base at one end, foldable over the folding struts, and connectable to the base at an opposite end to secure the folding struts against the base.

19. The bicycle luggage carrier according to claim 15 wherein the end support is movably connected to the base to move between retracted and deployed positions, the end support extending further past a respective end of the base in the deployed position than in the retracted position.

20. The bicycle luggage carrier according to claim 19 wherein the end support does not extend past the respective end of the base in the retracted position.
